(19) United States
(12) Patent Application Publication
(10) Pub. No.: US 2007/0260553 A1
(43) Pub. Date: Nov. 8, 2007

(54) System for the Secure Identification of the Initiator of a Transaction

(76) Inventor: Arie Ben Harush, Hanegev (IL)

Correspondence Address: Kevin D McCarthy;Roach Brown McCarthy & Gruber, 420 Main St, 1620 Liberty Bldg, Buffalo, NY, 14202, US

(21) Appl. No.: 10/582,745

(22) PCT Filed:
(86) PCT No.: PCT/IL04/01143

(30) Foreign Application Priority Data
Dec. 18, 2003 (IL) 159452

(51) Int. Cl. H04L 9/00

(52) U.S. Cl. 705/64

(57) ABSTRACT

In a method for identifying the initiator of a transaction carried out through computer network an order is sent by the initiator to the provider through the computer network. The initiator is identified and the desired transaction and the particulars of a second means of communication that belong to, or is controlled by, the initiator, are specified through a communication network. A period of time within which a confirmation should be sent by the initiator and received by the provider is then specified. If the confirmation is not received within the period of time, the order is disregarded. the confirmation and the order, if not previously sent, is transmitted to an Authentication Center (AC) that carries out an authentication procedure, which checks that all the data transmitted with the order message are correct, and that there are no particular conditions relevant to the implementation of the requested transaction. The results of the authentication procedure are forwarded to the provider and if found positive, the transaction is carried out.

### FIELD OF THE INVENTION

This present invention relates to a system for identifying with certainty the identity of a person who initiates a transaction by means of a computer system, particularly the Internet. The transaction thus initiated may involve a payment, and if so, the system of the invention also guarantees that the payment be effected.

### BACKGROUND OF THE INVNTION

Commerce through Internet is presently growing rapidly, and encompasses the purchase of goods, services and even information (e.g. it is possible to download music files for a fee). To make a purchase, a purchaser normally communicates purchase instructions via the Internet to a website operated by a seller. The instructions often include details of a credit card account held by the purchaser. The seller accepts the purchase and debits the purchaser's credit card of its price. However, this kind of payment is subject to a security problem, since, if the purchaser has obtained the number of a credit card that is not his own but that of a third party, he may succeed in causing said third party to be debited with the price of the sale.

Often, a single purchaser will make multiple purchases from the same website over an extended period of time. In order to avoid the necessity for a purchaser of transmitting the same credit card data repeatedly, and in order to minimize the risk of its data being intercepted by a third party, the website maintains a database of credit cards information for many purchasers. Each purchaser is supplied with (or chooses) identification data. Normally, the Identification data includes a password and a purchaser name. Whenever a purchaser wishes to make a purchase from the website, he supplies the website with his identification data. The website uses the Identification data to access the database of credit card data, and extracts the credit card information for the purchaser.

This arrangement exacerbates the security problem, since any intruder who gains access to the identification data can use the website to make purchases. Such an intruder may be, for example, a person who is connected, in one way or the other, to the seller. Alternatively, the intruder may gain access to the identification data because the purchaser has recorded it somewhere (e.g., on a paper) to avoid having to remember it.

Although the problem of security, associated with Internet and other kinds of data networks, is particularly acute whenever performing “online” purchasing, it also arises in other cases. For example, there are many occasions in which a purchaser wishes to communicate securely with a website. For example, employees of an organization usually have an access to the data network of their organization only while the employees are at their usual working environment (i.e., office). This is so because the computer stations of these employees and the identification data (i.e., purchaser name and password) of the employees are known to the supervisor of the organization (“firewall”). However, once an employee leaves his office, and unless he carries his office's computer with him and uses it, he will not be able to access to the data network of his organization from a remote place. This is because other computers (e.g., the employee's private laptop) will not be recognized by the firewall as a legitimate computer, and, therefore, any attempt to access the organization data network will be denied.

Due to the rapid development of the Internet, an electronic commerce, a home banking and a home office work, are increasing. To prevent personal credit card information and important information from being leaked and damaged by intruders, a variety of security systems and purchaser authentication systems have been developed. Among them is a password encryption system, which however has an inherent technological limitation due to the need of using encryption and decryption devices. Further, an intruder may rather easily steal transmission data such as an ID and a password on a connection path, and decrypt the received/intercepted transmission data. An intruder may, therefore, be erroneously authenticated by the seller as the authorized purchaser.

One way of coping with the problem raised by the interception of data passed via one communication path/link, is to utilize a second connection path, usually a telephone connection, for authenticating the purchaser. Such a solution is described in, e.g., GB 2 362 489, GB 2 362 543, WO 00/44130 and in WO 01/15381. However, the second connection path described (telephone connection) is used for forwarding additional information to a website server, the additional information being usually an additional password, which is compared to a password known to the website server. The additional information may be intercepted by others, in the same manner as the data forwarded via the first communication path/ink.

It is an object of the present invention to provide a system for obtaining secure identification of persons who initiates transactions of any kind.

It is another object to provide such a system that is very simple, but yet effective, and very easy to implement.

It is a further object to provide such a system which is applicable to transactions involving payment, hereinafter broadly referred to as “purchases”, as well as to transactions which may involve no payment, hereinafter broadly referred to as “access to information”.

It is a further object of the present invention, when the transaction is a purchase, to provide a purchaser identification System that is applicable both to one-time and to multiple transactions.

Broadly, it is the essential object of the invention to securely identify a person who initiates a transaction, no matter what said transaction is, whenever the person's identity is relevant.

Other objects and advantages of the invention will become apparent as the description proceeds.

### SUMMARY OF THE INVENTION

It may be said that whoever initiates a transaction requests and wishes to obtain what may be broadly called “a service”. In the term “service” as used herein are comprised the purchase and/or delivery of goods, the performance of operations other than said purchase and/or delivery of goods, or the permission to accede a database and in general information and/or to carry out operations involving said database or information. From another viewpoint, the services may be divided into services that have a monetary price and services that do not have such a price. The services that have a monetary price may be broadly called “sales”, the physical or juridical person who requests the service being the “purchaser” and the physical or juridical person who provides it being the “seller”. The services that do not have a monetary price may be broadly called “accesses”, the physical or juridical person who requests the service being the “applicant” and the physical or juridical person who permits or grants the access being the “grantor”. Hereinafter, for the sake of brevity, the male pronoun will be used to refer to the purchaser, the applicant, the seller or the grantor, but it is understood that the female pronoun is implicitly included and juridical persons are also included, and thus “he” means “he or she or it” and “his” means “his or her or its”.

The purchaser and the applicant may be called collectively “the initiator” and the seller and the grantor may be called collectively “the provider”.

With regard to sales, the system of the invention guarantees that the sale will be carried out successfully, because it ascertains that the purchaser is the person that he declares to be and is entitled to use the means of payment that he declares he intends to use.

With regard to services that are not sales but accesses, the system of the invention guarantees that the applicant is the person that he declares to be and is entitled to acquire the information and to make of it the use that he declares he intends to make.

No matter what the transaction, the initiator sends a first message, hereinafter an “order message” or, briefly, “order”, in which he identifies himself and specifies the desired transaction. Additionally, he must declare means for communication through a network that is not the computer network through which the transaction is to be carried out, hereinafter his “secondary means of communication”, that belongs to him or of which he has control. Typically, said secondary means of communication is a telephone, particularly a cellular phone, to which reference will be made hereinafter for purposes of illustration and not of limitation. Through his cellular phone, the initiator sends a second message, hereinafter a “confirmation message” or, briefly, “confirmation”. The content of the confirmation is irrelevant to the invention and may be altogether lacking, viz. said second message might even be an empty one, but must be sent through communication means and a communication network that are different from the means and the network through which the order was sent. The confirmation must be sent within a specified, short time interval following the sending of the order, which specified time interval must be known to the purchaser or applicant or be communicated to him before or immediately after the seller or grantor receives the order message. If said confirmation is not sent or is not received by the seller or grantor within said time interval, the order will be disregarded and will be as if it had never been sent, and the transaction will not take place even if a confirmation message should thereafter be received by the seller or grantor. The length of said specified time may vary from transaction to transaction, but should preferably not be longer than about two minutes.

According to a preferred embodiment of the invention, when the transaction is a purchase, the order, besides specifying the identity of the declared purchaser, the requested goods, and the secondary means of communication, comprises the price agreed for said goods and the means of paying said price. If the purchase should include negotiations, and therefore various messages between purchaser and seller, before a final agreement is reached, only the conclusive message that contains the specification of the desired goods and the agreed price, and is therefore binding and is a purchase order, will be considered herein to be the first message or order.

If the transaction is an access, and in other, exceptional cases as well, no price is to be paid and therefore no price is specified in the order, and it might be said that the agreed price is zero.

The order is sent by any suitable apparatus, for instance by PC, laptop, PALM, PDA or the like. It is sent through a computer network, and preferably through the Internet. However, it is possible, and may become increasingly possible, that a different network be used, as long as it includes both the purchaser or applicant and the seller or grantor.

The confirmation must be sent by the initiator, as stated hereinbefore, within a specified, and generally short, period of time. In a preferred embodiment of the invention, the confirmation is sent to the provider and communicated by this latter to an Authentication Center (AC). In another embodiment, if the AC is connected to the communication network through which the confirmation is sent, said confirmation may be sent directly to the AC and communicated by the AC to the seller. The AC checks that all the identification data transmitted with the order are correct, among them that the secondary communication means belong to the person who has identified himself as the initiator, and that the same person is the owner of the declared means of payment. It further checks, particularly in the case of accesses, that there are no particular conditions to be met for allowing the access. It should be remembered that what is called herein an “access” may not be limited to acquiring the knowledge of information, e.g. to entering a database, but may include performing operations on said information, e.g. adding, canceling or changing items of a database, and all this may be permitted only to specified persons. Therefore, the AC verifies that said access, within whatever broad limits it may be requested, is not denied to him for any reasons. In the case of purchases, in which the price is normally not zero, the AC verifies that there are not reasons for rendering the use of the declared payment means impossible or insufficient, e.g. that said payment means have sufficient funds to meet the agreed price of the purchase. If the authentication is positive, the AC informs of it the seller or grantor and the transaction may be carried out.

In some cases, additional information may be required of the initiator further to guarantee the transaction. Such information may be constituted by or include a password or a code word or number that should be known to the declared transaction initiator only.

For the sake of brevity, the computer network through which the order is sent will be described as the Internet, and the secondary communication means will be described as a cellular phone network. However, these descriptions should not be considered as limitations, but only as preferred embodiments.

In the case of purchases, the type of purchase and the payment means also define different embodiments of the invention. One of them is the one-time transaction, which is carried out by what is commonly called “micropayment”, and must be fully repeated for each purchase. The most preferred way of effecting the micropayment is to charge the account of a cellular telephone or of other second communication means. In this case, the fact that the purchaser is entitled to use the cellular telephone, or in general the communication means, by which he has sent a confirmation message, proves that he is entitled to pay by the payment means indicated, and the content of the confirmation message is irrelevant, to the extent that said message might even be empty: the fact that it was sent by the declared purchaser is a sufficient guaranty. Then, all that the AC must verify is that the owner of the cellular phone or other second communication means is indeed the person that declared himself to be the purchaser in the order message, and that there are no reasons why the account of the cellular phone or other second communication means should not be responsible for the payment. The AC of course will also verify that there are no particular limitations for the purchaser to carry out the requested transaction. The AC need not register other data nor needs the seller: each transaction stands by itself. Examples of such purchases are the order, from a virtual store (in a data network), of a book or a music disk, or the downloading of payable entertainment digital files, such as music or video files.

Additionally to the possibility of debiting a cellular phone account, or like methods of payment, E-mail based payment systems or other electronic, or web-based, systems may be used in this embodiment of the invention, and there is no need to pre-store details of purchasers in a database. Three exemplary email-based payment systems are:
1) Mllicent, a micro-payment system implemented by Digital Equipment Corp, now owned by Compaq, which handles electronic wallets starting at 1000 yen and payments as small as 5 yen (approximately $0.04 at launch time);
2) The AuricWeb system, which allows Internet Service Grantors (ISPs) to document online transactions along with other purchaser statistics, and
3) CyBank, which handles telephone billing models, prepaid cards and charges with respect to Internet purchases

In another embodiment of the invention, a purchaser may carry out multiple purchases by using the same means of payment. Typically, such means of payment may be a credit card or a bank account or other like means. In this case, the AC will extend its check to the said means of payment and will keep them in the database in connection with the identified purchaser; and the seller may keep the same data in a database of his own, though it is preferred that the AC should repeat, at each transaction that is an items of a multiple transaction system, the authentication that it has performed for the first such item.

The method disclosed in this invention is characterized in that the applicant declares his secondary means for communication through a network that is not the computer network through which the transaction, or request for service, is to be carried out, or granted, respectively. Then, the applicant establishes a second communication path/link with the grantor by using his secondary communication means. In response to the established second communication path/link, the secondary communication means is identified by the grantor and its identified identity is compared to the declared identification details. A positive identification of the applicant is assumed if they match. For example, if the secondary communication means is a telephone device, the declared detail is the call (or line) number of the telephone device, which can be easily identified by the end (grantor) receiving the call and compared to the declared telephone number. The grantor may (depending on the application) serve as a gateway to other services providers. Accordingly, after the identification of the applicant by the grantor, the grantor may route the applicant to a service provider, as requested by the applicant, or to requested information/data sources. The applicant is allowed to interact with the information/data sources according to the security, or authorization, level(s) granted to him in advance by the owner or operator of the information/data source. For this reason, the grantor keeps a list of updated potential applicants and their related security/authorization levels.

In order to be certain that the applicant is indeed a legitimate applicant, the declaration of the secondary communication means must reach the grantor's end within a short time period following the request for information/data or goods.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically represents the general features of the system of the invention; and

FIG. 2 is a flow sheet of embodiments of the invention.

### DETAILED DESCRIPTION OF PREFERRED EMBODIMENTS

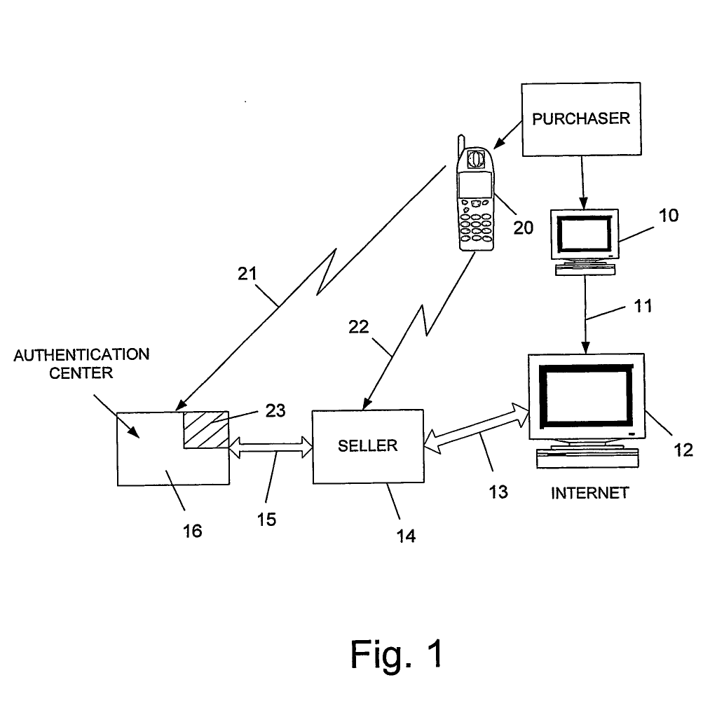

Referring now to FIG. 1, the initiator—purchaser or applicant—has first communication means that are connected to a computer network, typically a PC 10. The PC 10 is connected to the Internet, symbolically represented at 12, and transmits the request for a purchase or access to the Internet through computer network line 11. The Internet 12 has a two-way communication, as indicated at 13, with the seller 14, which in turn has a two-way communication as indicated at 15, with the authentication center 16.

As set hereinbefore, two possibilities exist in the implementation of an embodiment of the invention. The Authentication Center 16 may be connected to a telephone network, preferably a cellular telephone network. The initiator has a cellular telephone 20, and may send to the AC the second message through the cellular phone network, symbolically represented at 21. However this will require the AC to be connected to the cellular telephone network. This requirement is avoided if the initiator sends the second message from cellular telephone 20 directly to the seller or grantor, who of course is connected to the cellular telephone network, as symbolically indicated at 22. In this case the seller will transmit said second massage to the AC by the connection symbolically indicated at 15. In all cases the AC will exploit its database symbolically indicated at 23, and will transmit the results of the authentication process to the provider—seller or grantor. Depending on the results of the authentication process, positive or negative, either the transaction will be carried out or the order will be disregarded as if had never been sent, respectively. Likewise, the order will be disregarded if the confirmation message does not reach the seller or grantor, either directly or indirectly, within a specified, short period of time. Said period of time may also be graphically shown on the computer of the seller or grantor, and the order will be automatically disregarded if the confirmation message is not received within said period of time. It will be understood that the setting of a limited period of time for the confirmation message, will permit to prevent the overcrowding of the provider's computer or computers and of the corresponding network lines, which might occur if a large number of orders remain valid together for a period of time. This consideration may of course suggest that certain stages, if not all, of the management of the order be carried put automatically.

As has been said hereinbefore, the reference to Internet is not limitative and must be construed as implicitly extending to any computer means that are included in a computer network. Similarly, the reference to a cellular telephone is not limitative and must be construed to include any communication means, for example home telephones or radio stations, that are connected to a communication network.

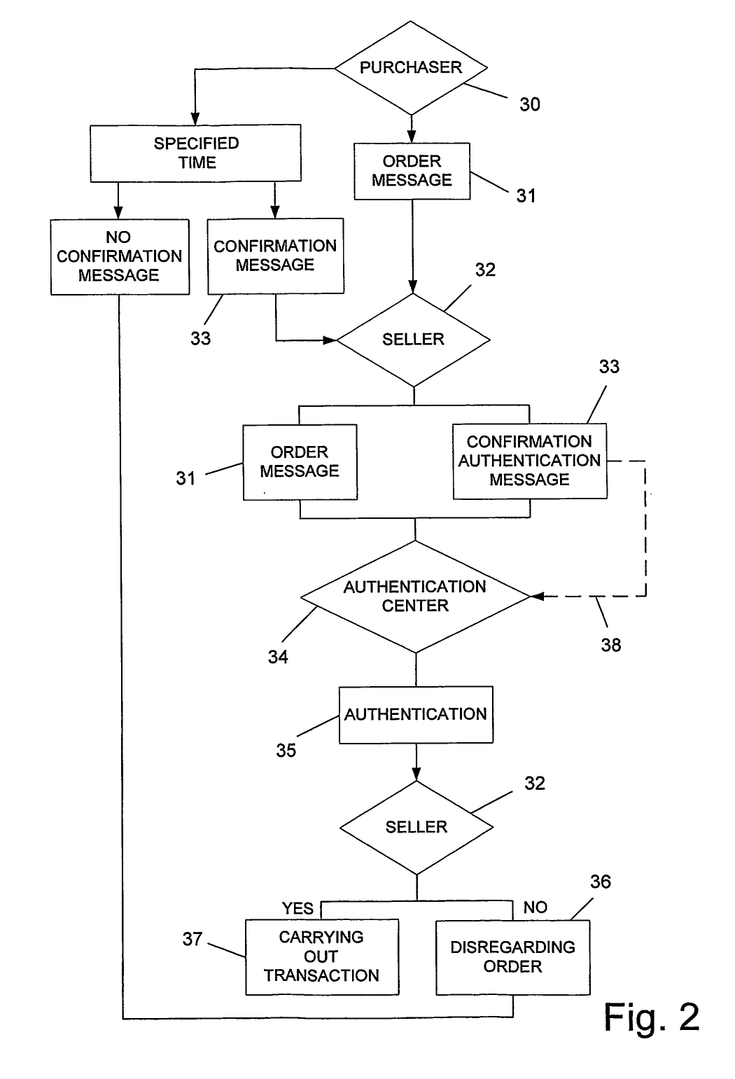

FIG. 2 is a flow sheet of a one-time transaction. FIG. 2 refers to a purchase, but its contents generally apply to an access as well. The purchaser sends the order message to Internet. The term “order (or first) message” has been defined hereinbefore. Internet transmits the order message to the seller. The seller transmits it to the AC. Within a prescribed time interval, the purchaser sends the confirmation (or second) message, in this example, to the seller, and the seller transmits it to the AC. As has been said before, the second message could be sent directly to the AC, if this latter has the means for receiving it. The AC carries out the authentication procedure. The (positive or negative) results of said procedure are transmitted to the seller, who correspondingly carries out or refuses to carry out the transaction. If he does carry it out, he charges the account of the cellular telephone with the agree price of the transaction.

FIG. 2 illustrates a one-time transaction. The purchaser (30) sends an order message (31) to seller (32) after a specified time passes, and if no confirmation is issued by the purchaser, the transaction is canceled as indicated at 36. If a confirmation (33) is issued by the purchaser and reaches the seller (32) within the specified time, the seller transmits order (31) and confirmation (33) to Authentication Center (34). The two messages may be transmitted together, since transmitting them at different moments is useless and may be confusing. However, the order may be transmitted to the AC before the confirmation, if so desired. After both messages have reached the Authentication Center (34), said Authentication Center carried out the authentication procedure (35) and transmits the result to the seller. If the result is negative, the order is disregarded as indicated at 36; if it is positive, the transaction is carried out as indicated at 37. In this flow sheet it is indicated that the confirmation is sent from the purchaser to the seller and from the seller to the AC, but if this latter has means for receiving the order message, it may be sent directly to it, as indicated at 38.

In a second embodiment of the invention, which may be additionally considered symbolically illustrated in FIG. 2, the purchaser uses the same payment means for multiple purchases and said payment means that cannot be guaranteed as belonging to the purchaser merely by the reception of a confirmation, since the identity of the sender of said confirmation with the owner of the designated payment means is not directly recognizable. To recognize it, it will be necessary to inspect at least one database, in which the payment means is registered as belonging to the person who sends the confirmation. An example of this second variant comprises the payment by credit card. In that case, the sender of the second message and the owner of the credit card can be recognized as being the same person by inspecting the relevant database. Generally, such payment means can be used for a number, or any number, of transactions, over the period of their validity.

However, said second embodiment too may be represented by the flow sheet of FIG. 2 only with the understanding that the authentication will include inspection of database that provide the AC with the confirmation of the fact that the sender of the confirmation is also the owner of the declared payment means and that there are no obstacles to the transaction. Though all the relevant data may be maintained in a data base of the AC or accessible to the AC, the authentication must be carried out for each transaction, and all the remaining stages and rules of the one-time transactions remain valid.

As has been said, additional information may be required to guarantee the transaction and may include the communication of passwords or codes that should be known to the purchaser or applicant. However, this additional information does not change the flow sheet of FIG. 2, but merely broadens the scope of the authentication stage.

While submitting the order, the purchaser normally is required to enter his cell phone number to the data network, which is then forwarded to the AC, for comparison with the second message sent to the AC the through the cellular phone network. Alternatively, if a higher authentication level is required, the purchaser can enter a password which corresponds to his cell phone number (rather than entering his uncovered cell phone number to the data network). In this case, the database of the AC should contain a cross-reference table for the interpretation of the entered password to the cell phone number of the purchaser, for proceeding with the authentication process.

The above embodiments have been described by way of illustration only, and it will be understood that the invention may be carried out with many variations, modifications and adaptations, without departing from its spirit or exceeding the scope of the claims.

1. A method for identifying the initiator of a transaction carried out through computer network, which comprises:
a) sending by the initiator to the provider, through said computer network, an order, wherein said initiator is identified and the desired transaction and the particulars of a second means of communication are specified through a communication network, said means belonging to, or being controlled by the initiator;
b) specifying a period of time within which a confirmation should be sent by said initiator and received by said provider;
c) if the confirmation is not received within said period of time, disregarding the order;
d) transmitting said confirmation and said order, if not previously sent, to an Authentication Center (AC);
e) carrying out by said AC an authentication procedure;
f) communicating to said provider the results of said authentication procedure; and
g) if said results are positive, carrying out the transaction.

2. A method according to claim 1, wherein the transaction is a purchase and the order specifies the requested goods, the price agreed for them, the means of paying said price.

3. A method according to claim 1, wherein the second means of communication is a telephone.

4. A method according to claim 3, wherein the telephone is a cellular phone.

5. A method according to claim 1, wherein the computer network is the Internet.

6. A method according to claim 1, wherein the period of time within which a confirmation should be sent by the initiator and received by the provider is not longer than two minutes.

7. A method according to claim 1, wherein the data checked in the authentication procedure comprise checking that the second communication means belongs to the person who has identified himself as the initiator.

8. A method according to claim 7, wherein the data checked in the authentication procedure comprise checking that the person who has identified himself as the initiator is the owner of the declared means of payment, and that there are no particular conditions relevant to the purchase of the requested goods by the declared purchaser, which may limit or prevent it.

9. A method according to claim 1, further comprising requiring of the initiator to provide additional information that should be known to the declared purchaser only.

10. A method according to claim 2, wherein the purchase is a one-time transaction, carried out by micropayment.

11. A method according to claim 2, wherein the purchase is an item of a multiple transaction.

12. A method according to claim 2, wherein the means of paying the price is the account of the second means of communication.

13. A method according to claim 2, wherein the means of payment is a credit card or a bank account.

14. A method according to claim 1, wherein the transaction is an information or data source, the order specifies a request for information/data and for manipulating them, and carrying out the transaction means granting the initiator an access to said information/data source according to security, or authority, level(s) that is/are pre-assigned to him by the operator of said information/data source.

15. A method according to claim 1, wherein the authentication procedure comprises checking that all the data transmitted with the order message are correct, and that there are no particular conditions relevant to the implementation of the requested transaction, which may limit or prevent it.

16. A system for identifying the initiator of a transaction through computer networks, which comprises:
a) a computer network;
b) a communication network;
c) for each initiator, computer means connected to said computer network and communication means connected to said communication network;
d) for each provider, computer means connected to said computer network and communication means connected to said communication network;
e) an Authentication Center connected to said provider through communication means; and
f) means, including database, for providing the data needed for authentication of the initiator, including his identity and his ownership of declared communication means and other relevant data, if any, said means being within said Authentication Center or being accessible by said Authentication Center.

17. A system according to claim 16, wherein the computer network is Internet.

18. A system according to claim 16, wherein the communication network is a telephone network.

19. A system according to claim 18, wherein the telephone network is a cellular telephone network.
